(19) United States
(12) Patent Application Publication
(10) Pub. No.: US 2017/0128881 A1
(43) Pub. Date: May 11, 2017

(54) DIESEL OXIDATION CATALYST WITH MINIMAL PLATINUM GROUP METAL CONTENT

(71) Applicant: Randal A. Goffe, Everett, WA (US)

(72) Inventor: Randal A. Goffe, Everett, WA (US)

(73) Assignee: PACCAR INC, Bellevue, WA (US)

(21) Appl. No.: 14/935,001

(22) Filed: Nov. 6, 2015

(51) Int. Cl. B01D 53/94; B01J 29/06; B01J 23/89; B01J 23/10; B01J 23/20

(52) U.S. Cl. CPC B01D 53/945; B01J 23/10; B01J 23/20; B01J 23/894; B01J 29/06; B01D 2255/407; B01D 2255/207; B01D 2255/40

(57) ABSTRACT

The present disclosure describes a diesel oxidation catalyst, including a metal oxide including a metal on a metal oxide surface, and less than 10 g/ft³ by weight of Pt or Pd, wherein the diesel oxidation catalyst oxidizes carbon monoxide and hydrocarbons of a diesel exhaust to carbon dioxide and water.

### BACKGROUND

Internal combustion engine exhaust emissions, and especially diesel engine exhaust emissions, have recently come under scrutiny with the advent of stricter regulations, both in the U.S. and abroad. While diesel engines are known to be more economical to run than spark-ignited engines, diesel engines inherently suffer disadvantages in the area of emissions. For example, in a diesel engine, fuel is injected during the compression stroke, as opposed to during the intake stroke in a spark-ignited engine. As a result, a diesel engine has less time to thoroughly mix the air and fuel before ignition occurs. The consequence is that diesel engine exhaust contains incompletely burned fuel known as particulate matter, or “soot”. In addition to particulate matter, internal combustion engines including diesel engines produce a number of combustion products including hydrocarbons (“HC”), carbon monoxide (“CO”), nitrogen oxides (“NOx”), and sulfur oxides (“SOx”). Aftertreatment systems may be utilized to reduce or eliminate emissions of these and other combustion products.

A number of catalysts are used to reduce emissions in diesel aftertreatment systems. FIG. 1A shows a block diagram providing a brief overview of a vehicle powertrain. The components include an internal combustion engine 20 in flow communication with one or more selected components of an exhaust aftertreatment system 24. The exhaust aftertreatment system 24 optionally includes a catalyst system 96 upstream of a particulate filter 100. In the embodiment shown, the catalyst system 96 is a diesel oxidation catalyst (DOC) 96 coupled in flow communication to receive and treat exhaust from the engine 20. The DOC 96 is preferably a flow-through device that includes either a honeycomb-like or plate-like substrate. The substrate has a surface area that includes (e.g., is coated with) a catalyst. The catalyst can be an oxidation catalyst, which can include a precious metal catalyst, such as platinum (Pt) or palladium (Pd), for rapid conversion of hydrocarbons, carbon monoxide, and nitric oxides in the engine exhaust gas into carbon dioxide, nitrogen, water, or NO₂.

Once the exhaust has flowed through DOC 96, the DPF 100 is utilized to capture unwanted diesel particulate matter from the flow of exhaust gas exiting engine 20, by flowing exhaust across the walls of DPF channels. The diesel particulate matter includes sub-micron sized solid and liquid particles found in diesel exhaust. The DPF 100 can be manufactured from a variety of materials including but not limited to cordierite, silicon carbide, and/or other high temperature oxide ceramics.

The treated exhaust gases can then proceed through diesel exhaust fluid doser 102 for the introduction of a reductant, such as ammonia or a urea solution. The exhaust gases then flow to a selective catalytic reduction (SCR) system 104, which can include a catalytic core having a selective catalytic reduction catalyst (SCR catalyst) loaded thereon.

System 24 can include one or more sensors (not illustrated) associated with components of the system 24, such as one or more temperature sensors, NOx sensor, oxygen sensor, mass flow sensor, and a pressure sensor.

As discussed above, diesel oxidation catalysts (DOCs) are used in the processing of engine exhaust for pollution control, as a key component of the engine aftertreatment system (EAS). There are three key roles for the DOC as an oxidation catalyst:
(1) Remove residual hydrocarbon (HC) that remains in the exhaust post-combustion in the engine.
(2) Convert toxic carbon monoxide (CO) byproduct from the combustion process to carbon dioxide (CO₂).
(3) Convert the pollutant nitric oxide (NO) to nitrogen dioxide (NO₂), which is required as an important oxidant in soot oxidation and for NOx reduction in post-DOC processing of engine exhaust gas.

Current industry trends are geared towards cutting costs, decreasing size and improving fuel economy, while simultaneously meeting the increasingly stringent pollution regulations. However, data from vehicle testing demonstrate that even higher Pt loading is required in the DOC when SCR catalysts are combined with diesel filters in a SCR on filter (SCRF). Indeed, Pt loading levels in the range of 40% higher than in conventional EAS configurations have been reported. The primary cause for the substantial increase in Pt loading is the increased need for NO₂-make in SCRF technology; based upon the competition between soot oxidation and the fast SCR reaction for optimal levels of NO₂.

Therefore, effective DOC compositions that utilize minimal amounts of platinum (Pt) and palladium (Pd) are highly desirable. Of Pt and Pd, both platinum group (PGM) metals, Pt is the most costly. But at the same time, of Pt and Pd, Pt is important for the oxidative processes and thus is the most abundant in DOC applications. To decrease costs and enhance efficiency, there is a need for catalyst formulations with low amounts of Pt and Pd. To be practical, the catalyst formulation should have good hydrothermal durability. The catalyst formulation should also be able to initiate a lightoff (or oxidation) process at a relatively lower temperature than Pt can achieve alone. The present disclosure seeks to fulfill these needs and provides further related advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, this disclosure features a diesel oxidation catalyst, including a metal oxide that includes a metal element on a metal oxide surface, and less than 10 g/ft³ by weight of Pt or Pd, wherein the diesel oxidation catalyst oxidizes carbon monoxide and hydrocarbons of a diesel exhaust to carbon dioxide and water.

In another aspect, this disclosure features a substrate including a coating of a diesel oxidation catalyst as described above, wherein the substrate is a catalytic converter support, a diesel particulate filter, or a combined catalytic converter support and a diesel particulate filter.

In yet another aspect, this disclosure features a method of oxidizing NO in diesel engine exhaust in a selective catalytic oxidation system, including exposing a NO-containing diesel engine exhaust to a diesel oxidation catalyst as described above, and oxidizing the NO to NO₂. The diesel oxidation catalyst is disposed on or within a catalyst support structure.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a block diagram of an example of an engine aftertreatment system coupled to an internal combustion engine.

FIG. 1B is a bock diagram of an example of an engine aftertreatment system coupled to an internal combustion engine.

FIG. 2 is a graph showing the conversion efficiencies of embodiments of DOC catalysts.

FIG. 3 is a graph showing NOx reduction efficiencies of embodiments of DOC catalysts.

FIG. 4 is a graph showing NOx reduction efficiencies of embodiments of DOC catalysts.

FIG. 5 is a scanning electron micrograph (top) and energy dispersive x-ray spectroscopy analysis (bottom) of a niobium pentoxide surface-modified YSC-10/Nb₂O₅.

FIG. 6 is a scanning electron micrograph (top) and energy dispersive x-ray spectroscopy analysis (bottom) of a niobium pentoxide surface-modified CeO₂—ZrO₂/Nb₂O₅.

FIG. 7 is a scanning electron micrograph (top) and energy dispersive x-ray spectroscopy analysis (bottom) of a niobium pentoxide surface-modified YSZ-8/Nb₂O₅.

### DETAILED DESCRIPTION

The present disclosure describes a diesel oxidation catalyst, including a metal oxide including a metal on a metal oxide surface, and less than 10 g/ft³ by weight of Pt or Pd, wherein the diesel oxidation catalyst oxidizes carbon monoxide and hydrocarbons of a diesel exhaust to carbon dioxide and water. The metal oxide can be in the form of a particle.

In some embodiments, the diesel oxidation catalyst includes a metal oxide with high oxidative power including a metal on the metal oxide surface, minimal amounts of Pd (e.g., 0.001 g/ft³) to ignite lightoff, and optionally minor amounts (e.g., 0.001 g/ft³) of Pt to enhance oxidation.

In some embodiments, the metal oxide is surface-modified with one or more metal elements, such as Nb, Ca, Sc, Ta, Ti, V, Cr, Mn, Mo, Al, Si, Ge, Ir, Os, Fe, Co, Ni, Cu, Y, Zr, Re, Ru, Rh, Pd, Pt, Ag, Ba, W, La, and/or Ce, each of which can be independently positively charged and/or uncharged. As used herein, “metal elements” include both uncharged metal elements and metal cations. The one or more metal elements can form an intimate layer with an underlying metal oxide. In some embodiments, the one or more metal elements are covalently bonded to the underlying metal oxide surface, where the one or more metal elements can occupy a location in the crystal lattice of the metal oxide in the form of a metal ion surrounded by the requisite number of oxide counter ions to achieve overall electrical neutrality.

In some embodiments, treatment of the metal oxide with organometallic compounds in organic solvents, followed by reduction of the organometallic compounds (e.g., with sodium formate reductant), creates a zone of amalgamation between the metal oxide surface and the metal of the organometallic compounds to create a catalyst with enhanced hydrothermal durability. The treatment of the metal oxide with organometallic compounds in organic solvents can provide control over the distribution and aging characteristics of catalytic centers at the surface of the catalyst.

### Metal Oxide

In some embodiments, the metal oxide is cerium oxide (e.g., CeO₂), titanium oxide (e.g., TiO₂), zirconium oxide (e.g., ZrO₂), aluminum oxide (Al₂O₃), silicon oxide (SiO₂), hafnium oxide (e.g., HfO₂), vanadium oxide (e.g., V₂O₅, V₂O₃, VO₂), niobium oxide (e.g., Nb₂O₅, NbO), tantalum oxide (e.g., Ta₂O₅, Ta₂O), chromium oxide (e.g., Cr₂O₃), molybdenum oxide (e.g., MoO₂), tungsten oxide (e.g., WO₃), ruthenium oxide (e.g., RuO₂), rhodium oxide (e.g., Rh₂O₃), iridium oxide (e.g., IrO₂), nickel oxide (e.g., NiO), barium oxide (e.g., BaO), yttrium oxide (e.g., Y₂O₃), scandium oxide (e.g., Sc₂O₃), calcium oxide (e.g., CaO), manganese oxide (e.g., MgO), lanthanum oxide (e.g., La₂O₃), strontium oxide (e.g., SrO), cobalt oxide (e.g., CoO, Co₂O₃, Co₃O₄), and any combination thereof. In some embodiments, the metal oxide is titanium oxide, zirconium oxide, and/or cerium oxide. In certain embodiments, the metal oxide is zirconium oxide and/or cerium oxide.

In some embodiments, the metal oxide in the catalyst composition has high thermal stability combined with electrical conductivity, ionic conductivity, or magnetic properties (e.g., paramagnetism, ferromagnetism, etc.). In some embodiments, the metal oxide is present in the form of a vanadate, niobiate, molybdate, borate, manganate, etc.

In some embodiments, the catalyst composition includes a metal oxide having a mixture of cationic dopants, such as (BaTiO₃)(SrTiO₃).

In some embodiments, the metal oxide in the catalyst composition is one or more of yttria-stabilized zirconia, yttria-stabilized ceria, or yttria-stabilized ceria-zirconia mixed oxide; barium zirconate (e.g., BaZrO₃), and/or yttria-doped barium zirconium oxide (a spinel oxide with high proton conducting properties, such as BaZr_{0.8} Y_{0.2}O₃).

Examples of vanadates include ziesite (a copper vanadate mineral with formula β-Cu₂V₂O₇), bismuth copper vanadate (e.g., BiCu₂VO₆); lithium nickel vanadate (e.g., LixNiVO₄, where x=0.8, 1.0, or 1.2, such as Li_{0.8}NiVO₄ or Li_{1.2}NiVO₄); iron vanadate (e.g., Fe₄(VO₄)₄.5H₂O); ferric vanadate (e.g., FeVO₄); nickel vanadate (e.g., Ni(VO₃)₂); nickel vanadium oxide (e.g., NiV₂O₆); zirconium vanadate (e.g., ZrV₂O₇, Zr(OH)₂(HOV₄)₂.2H₂O); cerium vanadate (e.g., ortho-Ce₂O₃.V₂O₅, pyro-2Ce₂O₃.3V₂O₅, meta-Ce₂O₃.3V₂O₅, CeVO₄, or CeV₂O₁₀); barium vanadate (Ba₃(VO₄)₂); and/or manganese vanadate (MnV₂O₆).

In some embodiments, the metal oxide is barium strontium titanate (Ba_{0.6}Sr_{0.4}TiO₃, a semiconducting perovskite oxide); and/or lanthanum strontium cobalt oxide (e.g., La_{0.6}Sr_{0.4}CoO₃, a semiconducting perovskite oxide).

The metal oxide includes a cationic dopant. The cationic dopant can be Sr²⁺, Ru⁴⁺, Rh³⁺, Mg²⁺, Cu²⁺, Cu³⁺, Ni²⁺, Ti⁴⁺, V⁴⁺, Nb⁴⁺, Ta⁵⁺, Cr³⁺, Mo³⁺, W⁶⁺, W³⁺, Mn²⁺, Fe³⁺, Zn²⁺, Ga³⁺, Al³⁺, In³⁺, Ge⁴⁺, Si⁴⁺, Co²⁺, Ni²⁺, Ba²⁺, La³⁺, Ce⁴⁺, Nb⁵⁺, Y³⁺, Sc³⁺, and Ca²⁺. In some embodiments, the dopant includes a rare-earth metal (e.g., Sc, Y, La, Ce, Pr, Nd, Pm, Sm, Eu, Gd, Tb, Dy, Ho, Er, Tm, Yb, and/or Lu), at any positive oxidation state. In some embodiments, the dopant is Ru, Rh, or Cu. For example, the cationic dopant can be Y³⁺, Sc³⁺, and/or Ca²⁺. In some embodiments, the cationic dopant is Y³⁺. In certain embodiments, the cationic dopant is Sc³⁺. In some embodiments, the cationic dopant is Ca²⁺.

In some embodiments, the metal oxide can include 0.001 mol % or more (e.g., 0.01 mol % or more, 0.1 mol % or more, 0.5 mol % or more, 1 mol % or more, 2 mol % or more, 5 mol % or more, 7 mol % or more, 10 mol % or more, 15 mol % or more, 20 mol % or more, 25 mol % or more, 30 mol % or more, 35 mol % or more) and/or 40 mol % or less (e.g., 35 mol % or less, 30 mol % or less, 25 mol % or less, 20 mol % or less, 15 mol % or less, 10 mol % or less, 7 mol % or less, 5 mol % or less, 2 mol % or less, 1 mol % or less, 0.5 mol % or less, 0.1 mol % or less, or 0.01 mol % or less) of the cationic dopant, relative to the total metal oxide composition (i.e., the metal oxide and any cationic dopants). For example, the metal oxide can include between 0.1 mol % and 25 mol % (e.g., between 0.1 mol % and 15 mol %, between 0.1 mol % and 10 mol %, between 5 and 10 mol %, or between 5 and 15 mol %) of the cationic dopant, relative to the total metal oxide composition. In some embodiments, the metal oxide includes about 3 mol %, about 8 mol %, or about 20 mol % of the cationic dopant, relative to the total metal oxide composition. As used herein, the term “about” indicates that the subject value can be modified by plus or minus 5% and still fall within the described and/or claimed embodiment.

In some embodiments, when the cationic dopant is Y³⁺, Sc³⁺, and/or Ca²⁺, the metal oxide can include 0.1 mol % or more (e.g., 0.5 mol % or more, 1 mol % or more, 2 mol % or more, 5 mol % or more, 7 mol % or more, 10 mol % or more, 15 mol % or more, 20 mol % or more, 25 mol % or more, 30 mol % or more, 35 mol % or more) and/or 40 mol % or less (e.g., 35 mol % or less, 30 mol % or less, 25 mol % or less, 20 mol % or less, 15 mol % or less, 10 mol % or less, 7 mol % or less, 5 mol % or less, 2 mol % or less, 1 mol % or less, or 0.5 mol % or less) of the cationic dopant, relative to the total metal oxide composition. For example, the metal oxide can include between 0.1 mol % and 25 mol % (e.g., between 0.1 mol % and 15 mol %, between 0.1 mol % and 10 mol %, between 5 and 10 mol %, or between 5 and 15 mol %) of Y³⁺, Sc³⁺, and/or Ca²⁺. In some embodiments, the metal oxide includes about 3 mol %, about 8 mol %, or about 20 mol % of Y³⁺, Sc³⁺, and/or Ca²⁺.

In some embodiments, the metal oxide is yttria-doped zirconia (i.e., yttria-stabilized zirconia). In some embodiments, the metal oxide is yttria-doped ceria (i.e., yttria-stabilized ceria). In some embodiments, the metal oxide is yttria-doped mixed zirconia and ceria. The yttrium can be present in an amount of about 3 mol %, about 8 mol %, or about 20 mol % relative to the total metal oxide composition. In some embodiments, the yttrium is present in an amount of about 8 mol %, relative to the total metal oxide composition. In some embodiments, the metal oxide is scandia-doped zirconia and/or ceria (i.e., scandia-stabilized zirconia and/or ceria). The scandium can be present in an amount of about 3 mol %, about 10 mol %, or about 20 mol %, relative to the total metal oxide composition. In some embodiments, the scandium is present in an amount of about 10 mol %, relative to the total metal oxide composition. In some embodiments, the metal oxide is calcium-doped zirconia and/or ceria (i.e., calcium-stabilized zirconia and/or ceria). The calcium can be present in an amount of about 5 mol %, about 10 mol %, about 16 mol %, or about 20 mol % relative to the total metal oxide composition. In some embodiments, the calcium is present in an amount of about 16 mol %, relative to the total metal oxide composition.

In some embodiments, the metal oxide is surface-modified with one or more metal elements, such as Nb (e.g., Nb⁵⁺, Nb⁴⁺), Ca (e.g., Ca²⁺), Sc (e.g., Sc³⁺), Ta (e.g., Ta⁵⁺), Ti (e.g., Ti⁴⁺), V (e.g., V⁴⁺), Cr (e.g., Cr³⁺), Mn (e.g., Mn²⁺), Mo (e.g., Mo³⁺), Al (e.g., Al³⁺), Si (e.g., Si⁴⁺), Ge (e.g., Ge⁴⁺), Ir (e.g., Ir⁴⁺), Os (e.g., Os⁴⁺), Fe (e.g., Fe³⁺), Co (e.g., Co²⁺), Ni (e.g., Ni²⁺), Cu (e.g., Cu⁺), Y (e.g., Y³⁺), Zr (e.g., Zr⁴⁺), Ru (e.g., Ru⁴⁺), Rh (e.g., Rh³⁺), Pd (e.g., Pd²⁺), Pt (e.g., Pt²⁺), Ag (e.g., Ag⁺), Ba (e.g., Ba²⁺), W (e.g., W⁶⁺, W³⁺), La (e.g., La³⁺), Re, Ce (e.g., Ce⁴⁺), each of which can be independently positively charged. As used herein, “metal elements” include both uncharged metal elements and metal cations. The one or more metal elements can form an intimate layer with an underlying metal oxide surface. In some embodiments, the one or more metal elements are covalently bonded to the underlying metal oxide surface, where, the one or more metal elements can occupy a location in the crystal lattice of the metal oxide in the form of a metal ion surrounded by the requisite number of oxide counter ions to achieve overall electrical neutrality. When the metal oxide is surface-modified, the metal oxide can further catalyze the conversion of NO to NO₂ and facilitate the NOx conversion to N₂ and H₂O, and/or the conversion of hydrocarbons to CO₂ and H₂O.

The metal element can be present in or on a metal oxide in an amount of 0.001 wt % or more (e.g., 0.01 wt % or more, 0.1 wt % or more, 1 wt % or more, 5 wt % or more, 10 wt % or more, 15 wt % or more, 20 wt % or more, 25 wt % or more, 30 wt % or more, or 35 wt % or more) and/or 40 wt % or less (e.g., 35 wt % or less, 30 wt % or less, 25 wt % or less, 20 wt % or less, 15 wt % or less, 10 wt % or less, 5 wt % or less, 1 wt % or less, 0.1 wt % or less, or 0.01 wt % or less), relative to the total metal oxide composition (i.e., the metal oxide including any cationic dopants and metal elements). In some embodiments, the metal element is present in or on a metal oxide in an amount of about 0.001 wt %, relative to the total metal oxide composition. In some embodiments, the metal element is present in or on a metal oxide in an amount of about 0.1 wt %, relative to the total metal oxide composition. In some embodiments, the metal element is present in or on a metal oxide in an amount of about 5 wt %, relative to the total metal oxide composition. In some embodiments, the metal element is present in or on a metal oxide in an amount of about 15 wt %, relative to the total metal oxide composition. In some embodiments, the metal element is present in or on a metal oxide in an amount of about 25 wt %, relative to the total metal oxide composition. In some embodiments, the metal element is present in or on a metal oxide in an amount of about 40 wt %, relative to the total metal oxide composition.

In some embodiments, when the metal element is Pd or Pt, the Pd or Pt can each independently be present in the metal oxide in an amount of less than 10 g/ft³ (e.g., less than 8 g/ft³, less than 5 g/ft³, less than 3 g/ft³, less than 1 g/ft³, less than 0.1 g/ft³, less than 0.01 g/ft³, or less than 0.001 g/ft³). In some embodiments, the Pd or Pt can each independently be present in the metal oxide in an amount of 0.001 g/ft³ or more (e.g., 0.01 g/ft³ or more, 0.1 g/ft³ or more, 1 g/ft³ or more, 5 g/ft³ or more, or 8 g/ft³ or more) and/or 10 g/ft³ or less (e.g., 8 g/ft³ or less, 5 g/ft³ or less, 1 g/ft³ or less, 0.1 g/ft³ or less, or 0.01 g/ft³ or less). In some embodiments, Pd is absent in the metal oxide. In some embodiments, Pt is absent in the metal oxide. In certain embodiments, both Pd and Pt are absent in the metal oxide.

In some embodiments, the metal element is in the form of a layer having a thickness of from 0.001 nm (e.g., from 0.01 nm, from 0.1 nm, or from 0.5 nm) to 1 nm (e.g., to 0.5 nm, to 0.1 nm, to 0.01 nm). The layer can have a variety of morphologies, such as complex mosaic of functionalities (i.e., micro-environmental domains of different compositions of various mixed oxides) or a uniformly transformed surface layer. Without wishing to be bound by theory, it is believed that as the organometallic reagent penetrates the metal oxide surface layers and chemically reacts with the metal oxide, a range of different stoichiometry of the resulting amalgam can occur as a function of depth of penetration and as a function of access to the particle surface. It is believed that these stoichiometric differences can result in the existence of catalytically active species in two or more valency states, thereby enhancing the catalytic redox properties of the resulting catalyst. The surface modification methods described herein can anchor active metal element moieties into the upper layers and enable catalytic sites to grow from the anchor sites. The catalytic sites can be more stable and less likely to migrate (i.e., sinter or cluster), and less likely to lose activity over time under high temperature conditions, thereby affording more robust and more durable catalysts. In some embodiments, the surface-modified catalysts can enhance specific surface area for desirable reactions to occur on the surface of the catalyst.

In some embodiments, the surface-modified metal oxide can serve as storage for NOx and O₂. For example, the surface-modified metal oxide can participate in redox reactions in the DOC system.

### Catalyst Composition

In some embodiments, one or more metal oxides and one or more surface-modified metal oxides are mixed in any combination to form a catalyst composition. For example, the catalyst composition can include from 2 wt % (e.g., from 5 wt %, from 10 wt %, from 15 wt %, from 20 wt %, from 30 wt %, from 40 wt %) to 50 wt % (e.g., to 40 wt %, to 30 wt %, to 20 wt %, to 15 wt %, to 10 wt %, to 5 wt %) of the surface-modified metal oxide, so long as the sum of the total amount of components of the catalyst composition is 100%. When viewed microscopically, the catalyst composition can appear as a mixture of metal oxide particles and surface-modified metal oxide particles. If a metal element is present, the metal element can form an intimately mixed layer with the surface of the metal oxide. The metal element can form a continuous or discontinuous coating on the surface of the metal oxide. The coating can have a thickness of from 0.001 nm (e.g., from 0.01 nm, from 0.1 nm, from 1 nm, from 10 nm, from 100 nm, or from 500 nm) to 1,000 nm (e.g., to 500 nm, to 100 nm, to 10 nm, to 1 nm, to 0.1 nm, or to 0.01 nm). In some embodiments, when viewed microscopically, the catalyst composition is in the form of a particle or a coating.

Without wishing to be bound by theory, it is believed that in the catalyst composition, the surface-modified metal oxide can have increased hydrothermal stability compared to the non-surface modified metal oxide.

### Synthesis

The surface-modified metal oxide can be made using the following synthetic methods. Synthetic methods are also described and exemplified in U.S. Ser. No. 14/934,955 (attorney docket no. PCCR154479), entitled “Surface-Modified Catalyst Precursors for Diesel Engine Aftertreatment Applications,” filed concurrently with the present application and herein incorporated by reference in its entirety.

In some embodiments, the method includes providing a solution including an organic solvent and an organometallic compound; mixing the solution with a metal oxide to provide a mixture; drying the mixture; and calcining the mixture to provide a surface-modified metal oxide catalyst. The organometallic compound can be, for example, a metal alkoxide, a metal carboxylate, a metal acetylacetonate, and/or a metal organic acid ester.

In some embodiments, the method further includes exposing the surface-modified metal oxide catalyst to a solution including metal salts, such as a solution including nickel ions and/or copper ions. The method can further include calcining the surface-modified metal oxide catalyst after exposing the surface-modified metal oxide catalyst to a solution including metal salts (e.g., nickel ions, copper ions).

In some embodiments, mixing the solution with a metal oxide is done by milling and/or stirring, so long as the mixing ensures that the mixture is homogeneous, i.e., with minimal aggregation and/or clumping of the mixture.

In some embodiments, drying the mixture is done by air drying, and/or by heating at a temperature of from 20° C. (e.g., from 40° C., from 60° C., from 80° C., or from 100° C.) to 110° C. (e.g., to 100° C., to 80° C., to 60° C., or to 40° C.) to remove residual solvent in the mixture.

In some embodiments, calcining includes heating the mixture to a temperature of from 450° C. (e.g., from 475° C., from 500° C., from 525° C.) to 550° C. (e.g., to 525° C., to 500° C., to 475° C.) for a duration of from 0.5 to 5 hours (e.g., from 1 to 5 hours, from 2 to 5 hours, from 3 to 5 hours, from 4 to 5 hours, from 1 to 2 hours, from 1.5 to 2 hours, from 2 to 3 hours). Calcining the mixture removes organic materials from the mixture, such as from the organometallic compounds. When performed in the presence of oxygen, calcining can form metal oxides from the organometallic compounds, and/or can cause the organometallic compounds to react with a substrate, such as a metal oxide to form covalent bonds between the metal in the organometallic compounds and the substrate.

Without wishing to be bound by theory, it is believed that surface modification of a suitable substrate material (e.g., a substrate such as a metal oxide) enables the easy synthesis of catalysts with desired properties. In some embodiments, the surface-modified substrate material may then be incorporated into washcoat formulations and applied to suitable supports (e.g., cordierite, silicon carbide, metallic supports, etc.).

In some embodiments, rather than mixing a solution including an organic solvent and an organometallic compound with a metal oxide to provide a mixture; drying the mixture; and calcining the mixture to provide a surface-modified metal oxide catalyst; the catalyst is made by mixing the catalyst precursor components and the reagents in a slurry, applying the slurry to a substrate in an engine aftertreatment system, and calcining the slurry to obtain a surface-modified catalyst composition on the engine aftertreatment system substrate.

### Reagents

As discussed above, the method can include providing a solution including an organic solvent and an organometallic compound.

In some embodiments, the organometallic compound used for modifying a surface of a given substrate material (e.g., a metal oxide) is insoluble in water, sparingly soluble, or readily decomposes in water, but is soluble in organic solvents including alcohols (e.g., propanol, isopropanol, pentanol, butanol, octanol, decanol), ethers (e.g., diethyl ether, ethyl propyl ether, dipropyl ether, butyl propyl ether, pentyl propyl ether), and esters (e.g., ethyl acetate, methyl methanoate, propyl propanoate, ethyl propanoate, ethyl benzoate). Without wishing to be bound by theory, it is believed that a solvent having an optimal process temperature can allow the amalgamation of the metal element into the lattice structure of the upper atomic layers of substrate material, and/or achieve a coating of the metal element.

The organometallic reagent and the solvent can have the following characteristics:
1. The organometallic compound is sparingly soluble in water, totally insoluble in water, or decomposes in water. As used herein, “sparingly soluble” refers to a solubility of less than 1 g/L at 20° C.
2. The solvent can be capable of solubilizing organometallic compounds that can exhibit polar properties or the properties of ionic coordination complexes.
3. Water can serve as a non-solvent to aid in controlling the surface modification process. The water can be in any phase, such as adsorbed, vapor, or liquid.

The metal elements on the surface of the metal oxide can be readily formed from organometallic compounds. The organometallic compounds can react with water to precipitate the surface modifiers on a surface of a washcoat precursor material. In some embodiments, the organometallic compounds are soluble in organic solvents such as alcohols and ethers and the like, which are also miscible with water.

As an example, the organometallic compounds can be metal alkoxides; metal carboxylates, metal acetyl acetonates, and/or metal organic esters. Examples of metal alkoxides include metal ethoxides (e.g., titanium(IV) ethoxide; Ti(OC₂H₅)₄), metal propoxides (e.g., titanium(IV) isopropoxide; Ti[OCH(CH₃)₂]₄); metal butoxides (e.g., titanium(IV) butoxide (Ti(OCH₂CH₂CH₂CH₃)₄), barium tert-butoxide (C₈H₁₈BaO₂), etc.); metal pentoxides, methoxyethoxides such as yttrium 2-methoxyethoxide; Y(OEtOMe)₃), niobium (III) chloride 1,2-dimethoxyethane complex; NbCl₃.CH₃OCH₂CH₂OCH₃, niobium ethoxide, polynuclear and heterometallic alkoxides such as Re₄O_{6-y}(OCH₃)_{12+y}, Re₄₋ₓMoₓO_{6-y}(OCH₃)_{12+y}, Re₄₋ₓWₓO_{6-y}(OCH₃)_{12+y}, titanium isopropoxide, titanium ethoxide, zirconium ethoxide, tetraethyl orthosilicate, aluminum isopropoxide, niobium ethoxide, tantalum ethoxide, potassium tert-butoxide, [CrAl(OPrⁱ)₄]₃, Mn[Al(OPrⁱ)₄]₂, [Fe {Al(OPrⁱ)₄}₂ₒᵣ₃], Co[Al(OPrⁱ)₄]₂, Ni[Al(OPrⁱ)₄]₂, Ni[Ga(OPrⁱ)₄]₂, Ni[Nb(OPrⁱ)₆]₂, Ni[Ta[OPrⁱ]₆]₂, Ni[Zr₂(OPrⁱ)₉]₂, and Cu[Al(OPrⁱ)₄]₂. As used herein, “Prⁱ” indicates an isopropyl group.

Examples of metal carboxylates include zirconium acetato-propionate; Zr(acac)₄; dicalcium barium propionate, Ca₂Ba(C₂H₅COO)₆; zirconium propionate; Zr(CH₃CH₂COO)₄; lanthanum propionate; metal with chelating agents such as ethyl diamine and poly(ethyldiamine), phthalimide, where the metal is Zr, Ba, Ti, La, Sr, Ce, Nb, etc. In some embodiments, the metal chelate is

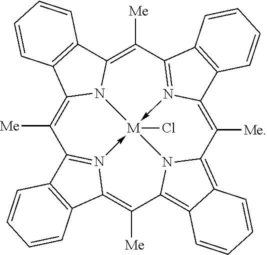

Examples of metal acetyl acetonates include titanium diisopropoxide bis(acetylacetonate) (CH₃)₂CHO]₂Ti(C₅H₇O₂)₂); zirconium (IV) acetylacetonate; Zr(C₅H₇O₂)₄; palladium(II) acetylacetonate, C₁₀H₁₄O₄Pd; platinum(II) acetylacetonate, Pt(C₅H₇O)₂; titanium bis(acetylacetonate)dichloride; vanadyl acetylacetonate; chromium acetylacetonate; manganese(III) acetylacetonate; iron acetylacetonates; ruthenium acetylacetonates; cobalt acetylacetonates; iridium acetylacetonates; nickel(II) acetylacetonate; copper acetylacetonate; and/or zinc acetylacetonate.

In some embodiments, the solution that includes an organic solvent and an organometallic compound further includes oligomers or low molecular weight polymers (e.g., less than 5,000 molecular weight), such as poly(propylene glycol), poly(ethylene glycol), and copolymers thereof. In certain embodiments, the low molecular weight polymer is poly (propylene glycol)-block-poly(ethylene glycol)-block-poly(propylene glycol) and/or H(OCH₂CH₂)ₙOH.

As an example, Table 1 lists the properties of vanadia and niobia, which can be taken into consideration when selecting niobia as a comparatively preferred surface modifier. As shown in Table 1, niobium ethoxide (a metal alkoxide) is an example of a suitable organometallic reagent as it readily reacts (i.e., decomposes) in water, and melts at a low temperature (5° C.) such that when it is calcined, it affords niobia, which is a highly stable compound that has a melting point of 1512° C. and that is insoluble in water.

TABLE 1
Niobium Pentoxide as a Surface Modifier

| Property | Vanadia | Niobia | Niobium Ethoxide |
|---|---|---|---|
| Molecular Formula | V₂O₅ | Nb₂O₅ | C₁₀H₂₅NbO₅ |
| Molecular Mass | 181.88 | 265.81 | 318.209 |
| (g/mol) | | | |
| Appearance | Yellow Solid | White Solid | White Solid |
| Density (g/cm3) | 3.357 | 4.6 | 1.258 |
| Melting Point (° C.) | 690 | 1512 | 5° C. |
| Solubility in Water | Soluble | Insoluble | N/A; reacts |
| (20° C.) | (0.8 g/L) | | with water |

Without wishing to be bound by theory, it is believed that niobium is suitable as a surface modifier because of its ability to migrate to grain boundaries of metal alloys where it can effectively bind the grains together, thereby markedly improving the density and overall strength of a given alloy.

The structure of niobium ethoxide is shown below in Scheme 1. It is believed that the strong tendency to form covalent bonds can be exploited to enable amalgamation of the Nb surface modifier with the selected substrate. Likewise, this property may help to bind grains of washcoat particles together and provide enhanced durability for a catalyst coating.

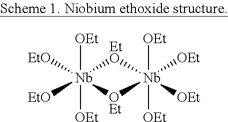

Other surface modifying metal oxides than Nb can be derived from organometallic reagents containing: Ca, Sc, Ti, V, Cr, Mn, Fe, Co, Ni, Cu, Y, Zr, Ru, Rh, Pd, Ag, Ba, W, La, Ce, Ta, Mo, Al, Si, Ge, Ir, Os, Re, and/or Pt.

### Applications

The diesel oxidation catalysts of the present disclosure have numerous advantages. For example, the diesel oxides catalysts can include a metal oxide with the combined properties of relatively high oxygen and NOx storage capacity, where both properties can be modulated by surface modification of catalyst precursors using organometallic compounds. In some embodiments, the diesel oxidation catalysts are hydrothermally stable when heated for 40 hours (e.g., 40 hours or more) at 650° C. (e.g., at 650° C. or more). In some embodiments, the diesel oxidation catalysts have a 50% hydrocarbon to CO₂ and H₂O conversion temperature of about 300° C. or less (e.g., 275° C. or less, or 250° C. or less). In some embodiments, the diesel oxidation catalysts have a 50% NO to NO₂ and H₂O conversion temperature of about 300° C. or less (e.g., 275° C. or less, or 250° C. or less).

The diesel oxidation catalysts of the present disclosure can be coated onto a substrate. For example, the substrate can be a catalytic converter support, a diesel particulate filter, or a combined catalytic converter support and a diesel particulate filter. In some embodiments, the substrate is a cordierite catalytic converter support, a cordierite wall flow filter, a silicon carbide wall flow filter, a ceramic fiber filter, and a metal fiber flow-through filter. The diesel oxidation catalysts can be disposed on or within a catalyst support structure, such as a ceramic monolith or a metallic substrate.

The diesel oxidation catalysts can be used for oxidizing NO in diesel engine exhaust in a selective catalytic oxidation system. For example, when a NO-containing diesel engine exhaust is exposed to a diesel oxidation catalyst of the present disclosure, which can be disposed on or within a catalyst support structure, NO is oxidized to NO₂. The diesel oxidation catalysts can further be used to oxidize a hydrocarbon in a hydrocarbon-containing diesel engine exhaust to CO₂ and H₂O.

In some embodiments, the surface-modified metal oxide has a smaller BET surface area compared to a metal oxide without surface modification. The reduced BET surface area is a quick an easy way to determine that the surface modification has taken place.

In some embodiments, the surface-modified metal oxide catalyst can modulate the oxidative power of the underlying metal oxide (e.g., a metal oxide such as ceria), and can facilitate selective catalytic oxidation (SCO) and the in situ formation of NO₂ reaction intermediates in environments where NO₂ concentrations are below the desired levels (i.e., NO₂/NOx=0.5). In some embodiments, the surface-modified catalyst compositions (e.g., barium oxide (BaO₂) surface-modified metal oxides) modulate NOx storage compared to non-surface modified compositions (e.g., zirconia-based metal oxides and ceria-based metal oxides), to meet low temperature emissions standards. As discussed above, the surface-modified catalyst compositions can enable low cost and compact platinum group metal-free diesel oxidation catalyst development.

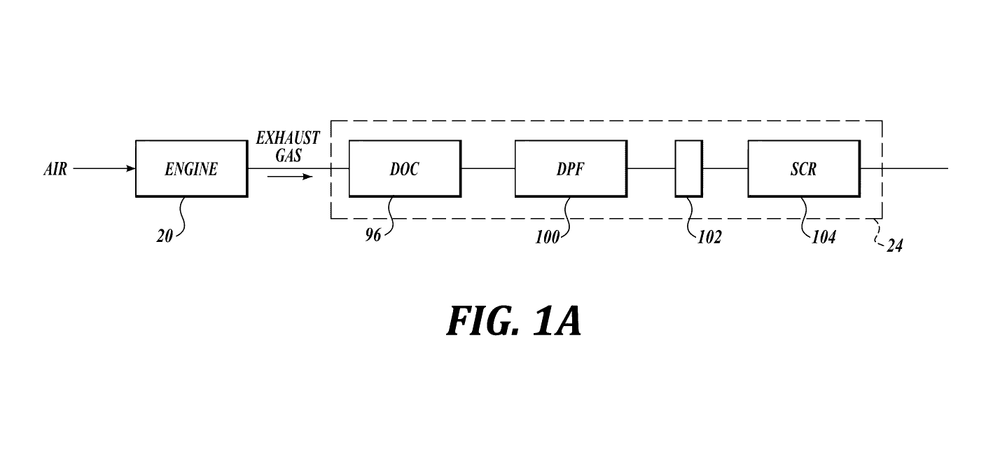

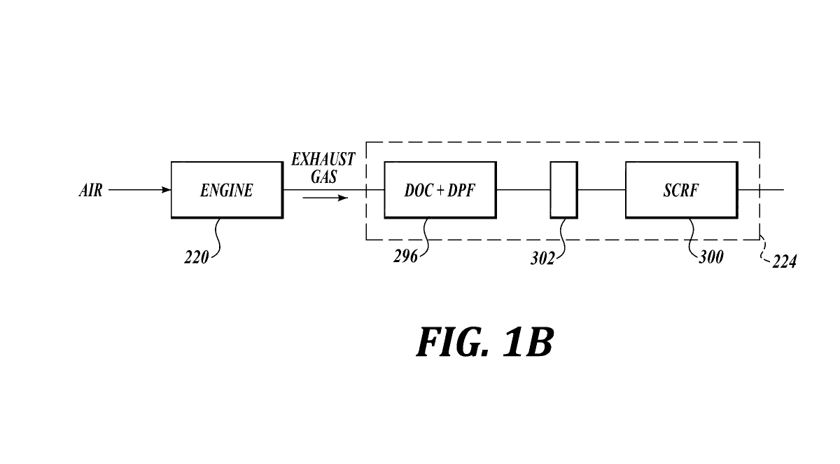

The surface-modified catalyst or a slurry containing non-surface modified metal oxide and organometallic reagents (i.e., catalyst precursors), can be applied in a variety of locations within an engine aftertreatment system. As described above, the slurry can be calcined to provide a surface-modified catalyst composition in an engine aftertreatment system. For example, referring to FIG. 1A, the diesel oxidation catalyst of the present disclosure can be used on a DOC substrate 96, which can be a flow-through device that includes either a honeycomb-like or plate-like substrate. In some embodiments, the diesel oxidation catalyst of the present disclosure can lead to more compact exhaust aftertreatment systems. For example, referring to FIG. 1B, an exhaust aftertreatment system 224 includes a combined diesel oxidation catalytic system (“DOC”) and a diesel particulate filter 296 upstream of a diesel exhaust fluid doser 302. The diesel oxidation catalyst of the present disclosure can be coated onto the combined DOC and DPF substrate 296. Downstream of the diesel exhaust fluid doser 302 is SCRF 300, which includes a DPF with a catalytic core having a selective catalytic reduction catalyst loaded thereon. Exhaust aftertreatment system 224 has a DPF both upstream and downstream of the mixer and therefore increases the filter capacity. As shown in FIG. 1B, exhaust aftertreatment system 224 is more compact than the exhaust aftertreatment system 24 shown in FIG. 1A.

The following examples are included for the purpose of illustrating, not limiting, the described embodiments.

Example 1 describes the screening and selection of NO₂-make catalysts. Example 2 describes the evaluation of DOC catalysts on a high porosity silicon carbide wall filter in an SCRF application. Example 3 describes the synthesis and characterization of niobia surface-modified metal oxides. Example 4 provides an example of a platinum-free DOC composition.

### EXAMPLES

### Abbreviations

YSZ: yttria-stabilized zirconia

YSC: yttria-stabilized ceria

PEG: poly(ethylene glycol)

PPG: poly(propylene glycol)

PEO: polyethylene oxide

DI water: deionized water

DOC: diesel oxidation catalyst

GHSV: gas hourly spatial velocity

NRE: NOx reduction efficiency

PGM: platinum-group metal

### Example 1

### NO₂-Make Catalyst Screening and Selection

The following washcoat composition was dip coated onto a cordierite (5/300) substrate (available from NGK Automotive Ceramics, U.S.A., Inc.), in the form of 1″×1″ core samples at 30° C., with a vacuum applied to pull excess washcoat through the channel and assist in drying: 25.6% YSZ-8 (MEL Chemicals); 8.3% YSC-10 (Sigma-Aldrich); 19.9% Nyacol® (Nyacol Nano Technologies); 3.4% PEG/PPG (Sigma-Aldrich); 0.3% PEO (Sigma-Aldrich); and 42.2% DI water. The washcoat was dried at 105° C. in air and calcined at 450° C. for 1 hr.

### DOC Light-Off Testing of Catalyst Washcoat on Cordierite Core Samples

A synthetic gas test bench for testing catalyst core samples was employed to evaluate various catalyst washcoats for their ability to activate undesirable oxidative side reactions. Their potential ability to oxidize the NH₃ (produced from DEF dosing) was also investigated.

Catalyst coated core samples were evaluated in a DOC lightoff experiment. A fresh core sample from a commercial DOC catalyst was used as a reference.

The gas mixture used at 60,000 GHSV to simulate a diesel exhaust was as follows: 600 ppm NO; 75 ppm C₂H₄; 300 ppm CO; 10% O₂; 5.6% CO₂; 6% H₂O; balance N₂; at 60,000 GHSV.

A reverse lightoff test procedure was employed, where the temperature was increased from 160° C. to the setpoint of 600° C., and it was allowed to stabilize. Heating was then discontinued and both the inlet temperature and the reactor outlet gas concentration were monitored.

From the results, conversion efficiencies were computed and plotted to obtain the temperature at which 50% of the total conversion efficiency was achieved for CO conversion to CO₂ (T₅₀CO); NO conversion to NO₂ (T₅₀NO); and C₂H₄ conversion to CO₂ and H₂O (T₅₀C₂H₄).

The results are shown in Table 2, where all of the tested catalysts could potentially be employed for NO₂-make catalyst, because they did not activate oxidative lightoff reactions below 500° C. in the absence of PGM catalytic species.

TABLE 2
DOC Light-off Properties of Redox Catalysts on Cordierite
(1″ × 1″) Core Samples

| | Washcoat Loading | T₅₀CO | T₅₀NO | T₅₀C₂H₄ |
|---|---|---|---|---|
| CATALYST | (g/L) | (° C.) | (° C.) | (° C.) |
| Commercial | Unknown | 138 | 242 | 247 |
| DOC Catalyst | | | | |
| YSZ-8 | 156 | >600 | N/A | 581 |
| YSZ-8/YSC-10 | 103 | 586 | N/A | 590 |
| YSZ-8/CeO₂—ZrO₂ | 224 | 550 | N/A | 573 |
| YSC-10 | 43 | 583 | N/A | 592 |

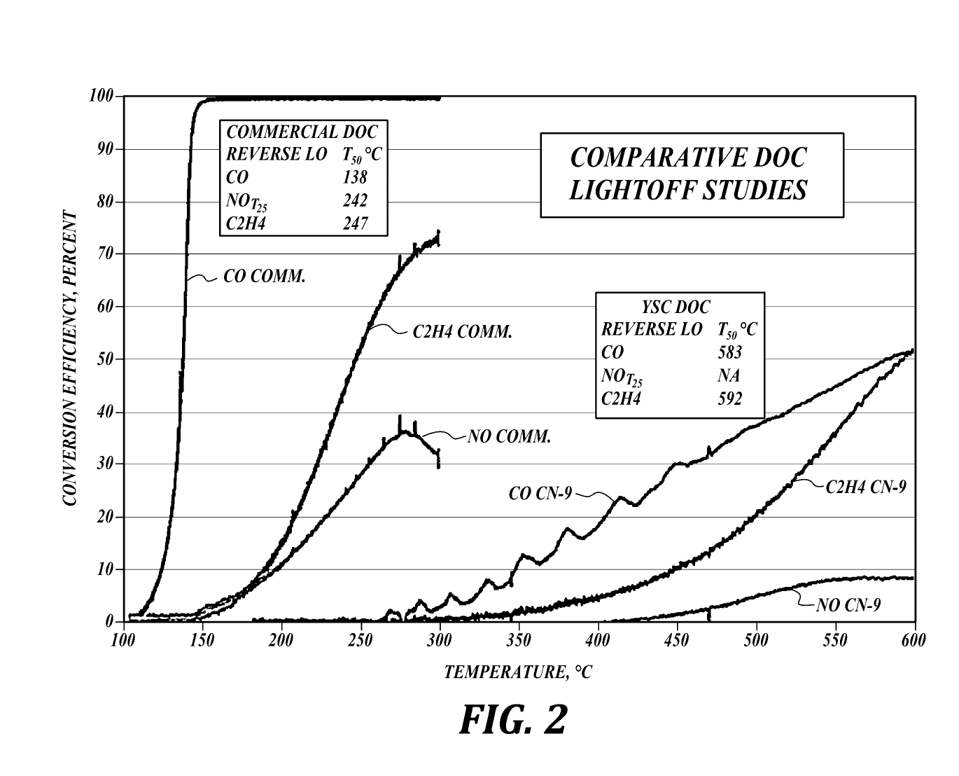

FIG. 2 is a graphical representation of the relative comparative DOC lightoff performance of a commercial DOC containing PGM and the yttria stabilized ceria (YSC) NO₂-make catalyst of this disclosure.

The NO₂-make catalyst of the disclosure can be selected from metal oxides which exhibit the least oxidative power, and as such will be the least likely to oxidize NH₃, while enabling the reaction and stabilization of NO₂ to facilitate high NOx reduction in NO₂-depleted exhaust streams. Therefore, taking Table 2 as an example, the screened NO₂-make catalysts are preferred in the order: YSZ>YSC>>CeO₂—ZrO₂.

### Example 2

### SCRF Evaluation on High Porosity Silicon Carbide (SiC) Wall Filters

Table 3 contains a summary of the composition of (1″×3″) core samples of high porosity SiC filter material that were coated with catalyst washcoat and tested for SCRF functionality (i.e., NOx reduction (i.e. conversion) efficiency to evaluate SCR function with and without soot, ΔP (i.e., change in simulated exhaust flow) as a function of soot loading, and soot lightoff temperature).

TABLE 3
SCRF Core Sample Composition

| | | NO₂ MAKE | | | |
|---|---|---|---|---|---|
| | SAM- | YSC-10 | | SCR | TOTAL |
| ITEM | PLE | CATALYST | METAL | CATALYST | CATALYST |
| # | # | (g/L) | TYPE | Cu ZSM-5 | (g/L) |
| 1 | 17 | 16.2 | None | 96.3 | 112.5 |
| 2 | 26 | None | None | 75 | 75 |
| 3 | 6 | 47.8 | Fe | 94.9 | 142.7 |
| 4 | 11 | 24.2 | Ag | 62.4 | 86.6 |
| 5 | 19 | 42 | Pd | 74.8 | 116.8 |
| 6 | 4 | 38.5 | Cu-1 | 53.7 | 92.2 |
| 7 | 5 | 36.8 | Cu-2 | 63.2 | 101.8 |
| 8 | 9 | 75.1 | Ni | 76.2 | 151.3 |
| 9 | 13 | 21.3 | Pt | 56.8 | 78.1 |
| 10 | 12 no | 19.8 | Pd | 68.3 | 88.1 |
| | data | | | | |

### Core Sample Preparation

SiC DPF core samples were dip coated with the vacuum aided technique described in Example 1, from the downstream side of the filter only. Washcoat compositions were as follows:

Optionally apply washcoat: 5.8% yttria stabilized ceria (10 mol %), 12.2% PEG-PPG (Mn ˜2,500), both from Sigma Aldrich, with 8.8% NYACOL ZR 10/15 (Nano Technologies Inc.), and 73.2% DI water, then dried at 105° C. for 1 hr.

Optionally treat with 1M (CuSO₄, FeCl₃, AgNO₃, or NiSO₄) or, dilute PdCl₂ or PtCl₂ solutions at 0.1M, followed 0.3 M Na formate, and dried at 105° C. for 1 hr and calcining at 450° C. for 1 hr.

Apply washcoat: 27% CuZSM-5 (from ACS as nanoZSM-5), 1.8% PEG-PPG, 10.8% NYACOL ZR 10/15, 0.8% PEG (300,000) and 58.9% DI water. Drying as conducted at 105° C. and calcining at 450° C. for 1 hr.

Standard pretesting (degreening) procedure for all samples: 4 hr @ 600° C. with 10% H₂O vapor.

### Core Sample Testing Sequence

1. Clean ΔP—with no soot in the filter

2. Clean NOx reduction efficiency (NRE): NO₂/NOx=0.5, NII₃/NOx, 35,000 GHSV, 500 ppm NOx; NH₃/NOₓ=1.

3. ΔP vs. collected soot

4. NRE with soot (same conditions as step 2)

5. Temperature programmed oxidation (TPO) of soot; i.e. soot lightoff temperature

### Evaluation of SCRF Functionality

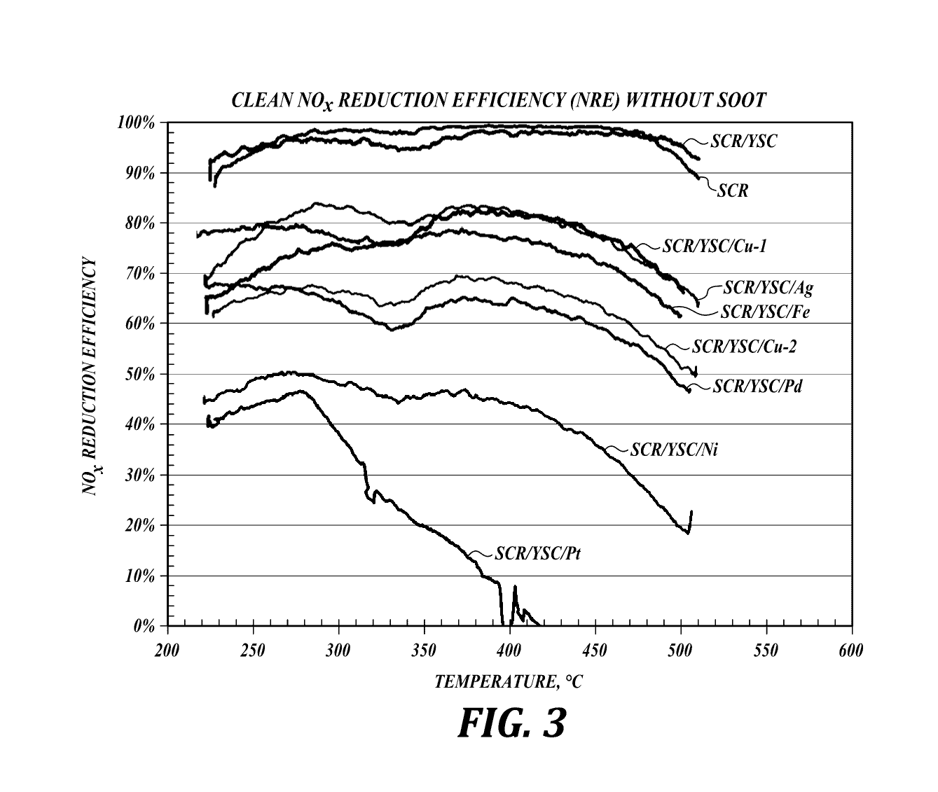

FIG. 3 shows the clean NOx reduction efficiency of various tested compositions, without soot. The data demonstrated the following:
1. An improved SCR catalyst (SCR in FIG. 3) based upon CuZSM-5, provides high NOx conversion efficiency for both low and high temperature conditions.
2. The binary catalyst (SCR/YSC) has similar high performance and apparent durability as the SCR core sample (in FIG. 3).
3. Treatment of the YSC layer with PGM and a variety of other metals prior to application of the SCR washcoat produced a range of NOx reduction efficiency consistent with the catalytic properties of the metal in redox reactions. Consequently, with the greater oxidative power of Pt (for example), there is a dramatic decline in NOx reduction efficiency; primarily due to the excessive NO₂-make, combined with NH₃ oxidation to produce large amounts of N₂O (FIG. 3).
4. The behavior of Ni and Pd reflected their use in selective oxidation and reduction processes (respectively) in electrochemical applications. Ni is particularly interesting because it had a uniquely low N₂O selectivity over the entire temperature range of about 230-530° C.
5. The behaviors of Cu, Fe, and Ag were more complex and exemplified the tradeoff between a number of properties, including SCO properties, low vs. high temperature NRE, thermal stability, required loading levels, and process costs.
6. Cationic treatment of the YSC layer provided the ability to simultaneously achieve optimal NRE (with NO₂-make in situ) and minimal N₂O from NH₃ oxidation. The performance of the metal modifiers was as follows: Ni>Ag>Cu, Fe>Pd>Pt.

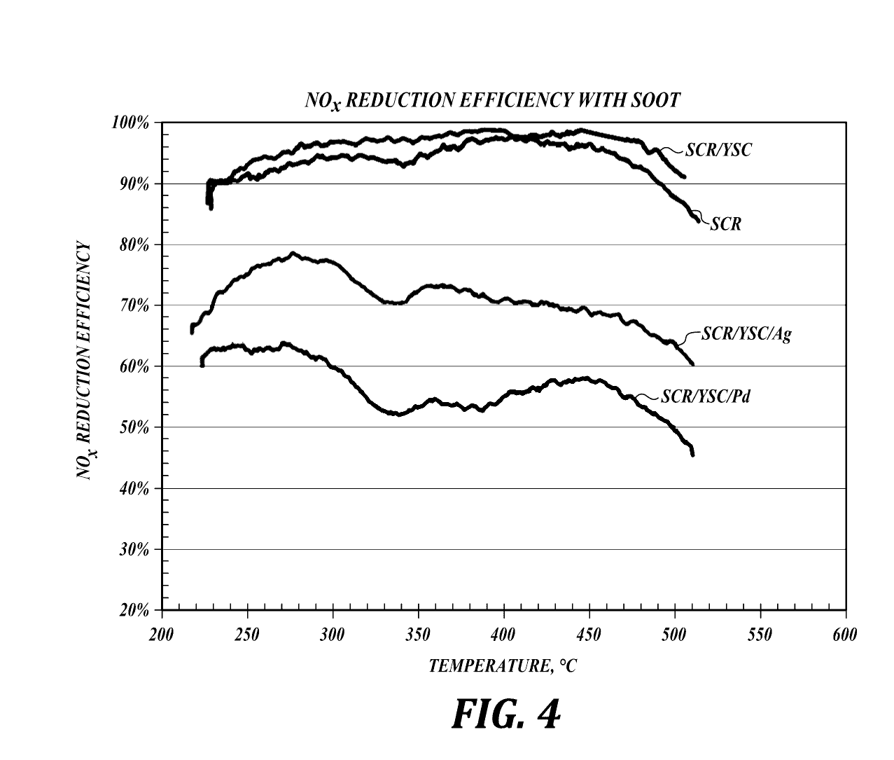

FIG. 4 is a compilation of NOx conversion efficiency data taken at a relatively low temperature of 230° C. in comparison with that at a relatively high temperature of 500° C., with and without soot loading for both a conventional SCRF catalyst and a catalyst of this disclosure. The impact of (3 g/L) of soot loading NOx conversion efficiency was different from that for conventional SCRF technology, as shown in Table 4 and FIG. 4. This data illustrates the fact that incorporation of NO₂-make catalyst into the washcoat improved low temperature NOx reduction efficiency over conventional SCRF technology both in the absence and presence of soot. The same conclusion was drawn when comparing NRE over the entire operating temperature range for the engine aftertreatment system.

TABLE 4
Effect of soot loading and temperature on NOx reduction efficiency

| State of DPF | CONVENTIONAL SCRF | | BINARY CATALYST SCRF | |
|---|---|---|---|---|
| Loading | 230° C. | 500° C. | 230° C. | 500° C. |
| Nil | 80% | 75% | 90% | 93% |
| Soot | 85% | 75% | 90% | 87% |
| (3-4 g/L) | | | | |

TABLE 5
Effect of soot and temperature on N₂ selectivity
in NH₃ oxidation (reported as N₂O make)

| State of DPF | CONVENTIONAL SCRF | | BINARY CATALYST SCRF | |
|---|---|---|---|---|
| Loading | 230° C. | 500° C. | 230° C. | 500° C. |
| Nil | 37 ppm | 9 ppm | 19 ppm | ~1 ppm |
| Soot | 13 ppm | 7 ppm | 15 ppm | 5 ppm |
| (3-4 g/L) | | | | |

TABLE 6
Effect of SCRF Catalyst Composition
on Onset of Soot Lightoff Temperature

| | | | | Onset of Soot |
|---|---|---|---|---|
| | Sample | SCRF Catalyst | | Lightoff |
| Item | ID | Composition | Source | (° C.) |
| 1 | Control | Cu-Chabazite on | Commercial | 345 |
| | | Cordierite DPF | | |
| 2 | SCR | CuZSM-5/ZrO₂ on | Synthesized | 345 |
| | | Hi SiC DPF | | |
| 3 | SCR/YSC | Binary Catalyst: | Synthesized | 362 |
| | | CuZSM-5/ZrO₂/ | | |
| | | YSC on Hi SiC | | |
| 4 | SCR/ | Binary Catalyst: | Synthesized | 350 |
| | YSC-Pd | CuZSM-5/ZrO₂/ | | |
| | | YSC-Pd on Hi SiC | | |
| 5 | SCR/ | Binary Catalyst: | Synthesized | 361 |
| | YSC-Ag | CuZSM-5/ZrO₂/ | | |
| | | YSC-Ag on Hi SiC | | |
| 6 | Blank | Hi SiC (65% porosity) | Commercial | 360 |

### Effect of Soot Loading on ΔP

The following is the ΔP after the initial phase of soot loading for the SCRF core samples tested:
(i) Sample # 26—ΔP ˜1.6 kPa at 0.1 g soot/L of the SCRF core
(ii) Samples # 5 and # 11 are similar to Sample #26
(iii) Sample # 19—ΔP ˜7.2 kPa at 0.2 soot/L of the SCRF core
(iv) Sample # 17—ΔP ˜1.6 kPa at 0.05 soot/L of the SCRF core
(v) Conventional Cu-zeolite (based upon a chabazite type of zeolite)—ΔP ˜7.4 kPa at 3.6 g/L

The data demonstrated the ability of low PGM DOC catalysts of the present disclosure to accomplish optimal catalytic performance with reduced ΔP compared to commercially available catalysts.

### Example 3

### Niobia Surface-Modified Redox Metal Oxide Catalyst Precursor

Niobium pentoxide (Nb₂O₅) surface modifier was applied to redox metal oxide catalyst precursors by reaction with niobium ethoxide dissolved in isopropanol (IPA) with:
1. zirconia stabilized with 8 mol % yttria (YSZ-8);
2. ceria stabilized with 10 mol % yttria (YSC-10); or
3. ceria—zirconia (CeO₂—ZrO₂).

Yttria stabilized zirconia was obtained from MEL Chemicals, while all other reagents were obtained from Sigma-Aldrich.

### Procedure

10% Niobium ethoxide was prepared in isopropanol and was added to the amount of two component redox metal oxides; in an amount sufficient to obtain a composition after calcining to form (Nb₂O₅) equivalent to:
1. 10 wt % NbEtO/90 wt % YSZ-8 [8 mol % yttria stabilized zirconia]
2. 10 wt % NbEtO/90 wt % YSC-10 [10 mol % yttria stabilized ceria]
3. 10 wt % NbEtO/90 wt % CeO₂—ZrO₂) [50% ceria in 50% zirconia]

The mixture was milled in a SPEX SAMPLEPREP MIXER MILL with methyl methacrylate balls for 20-30 minutes. Air drying in a fume hood was conducted, and over drying at 105° C. completed the drying process. Calcining was conducted by increasing the temperature to 500° C. at a rate of 15° C./minute. 500° C. was maintained for 5 hours and cooling was accomplished at a rate of 15° C./minute, down to 30° C.

The catalysts were characterized by X-ray diffraction, BET (Brunauer, Emmett, and Teller surface area analysis), SEM/EDAX (scanning electron microscopy and energy dispersive x-ray analysis), and Raman analytical techniques, by comparison with the corresponding untreated metal oxide.

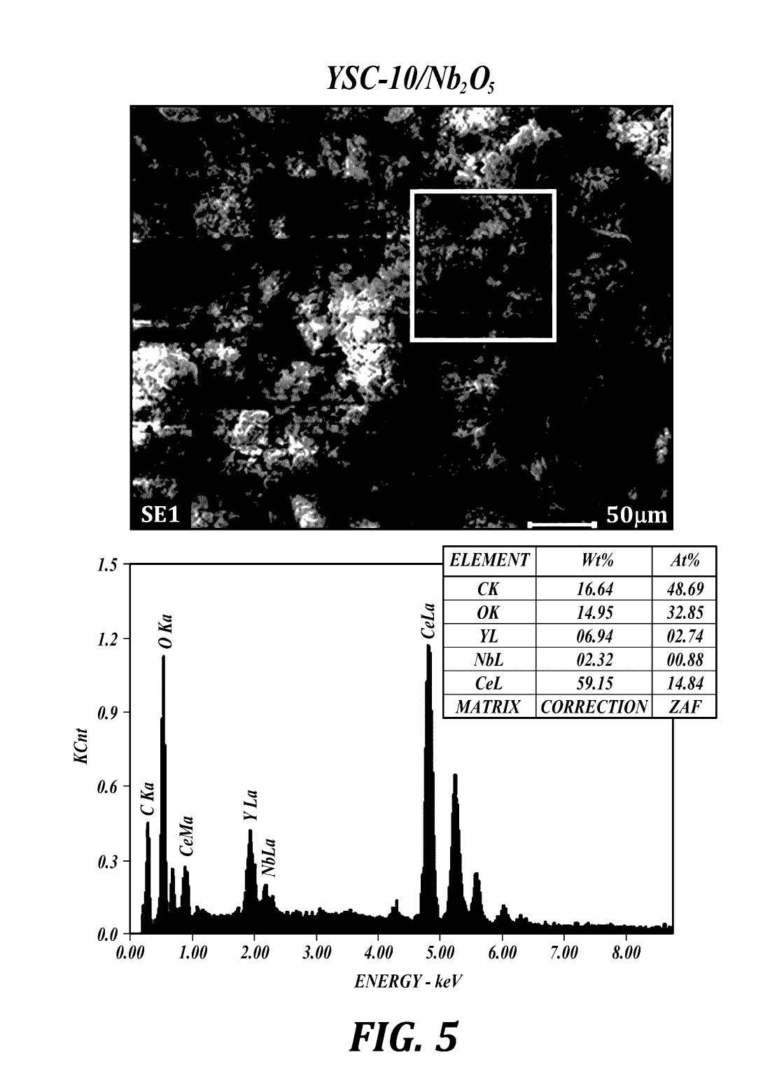

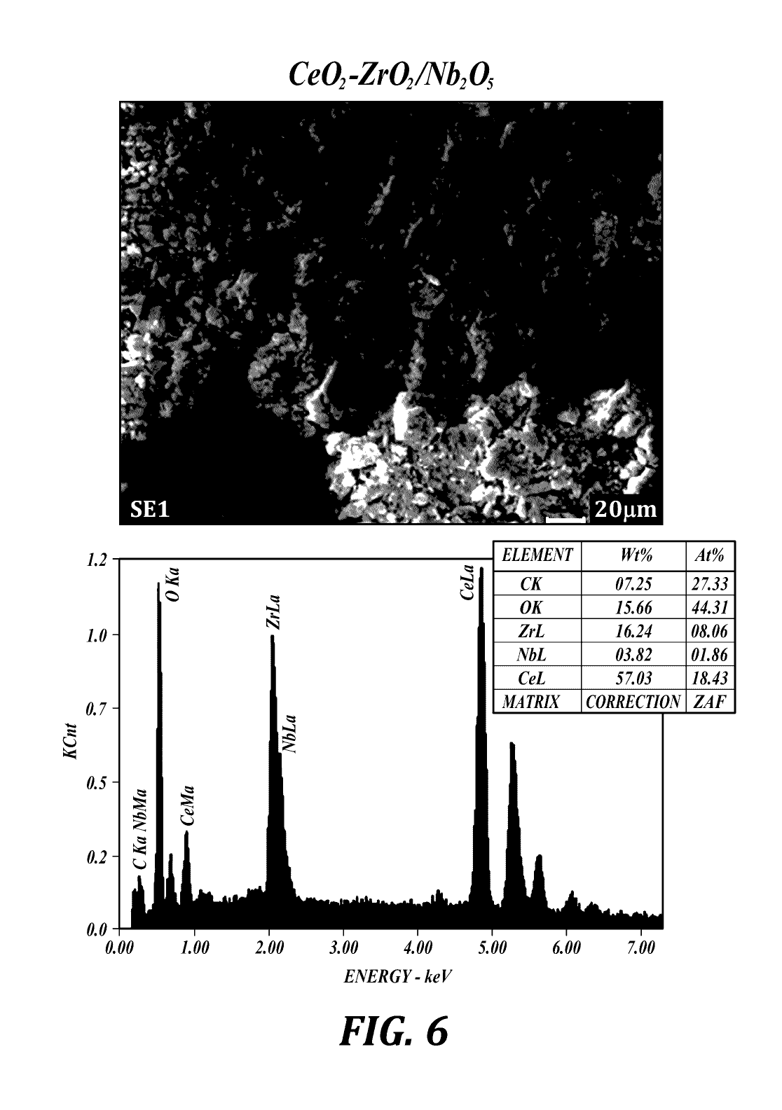

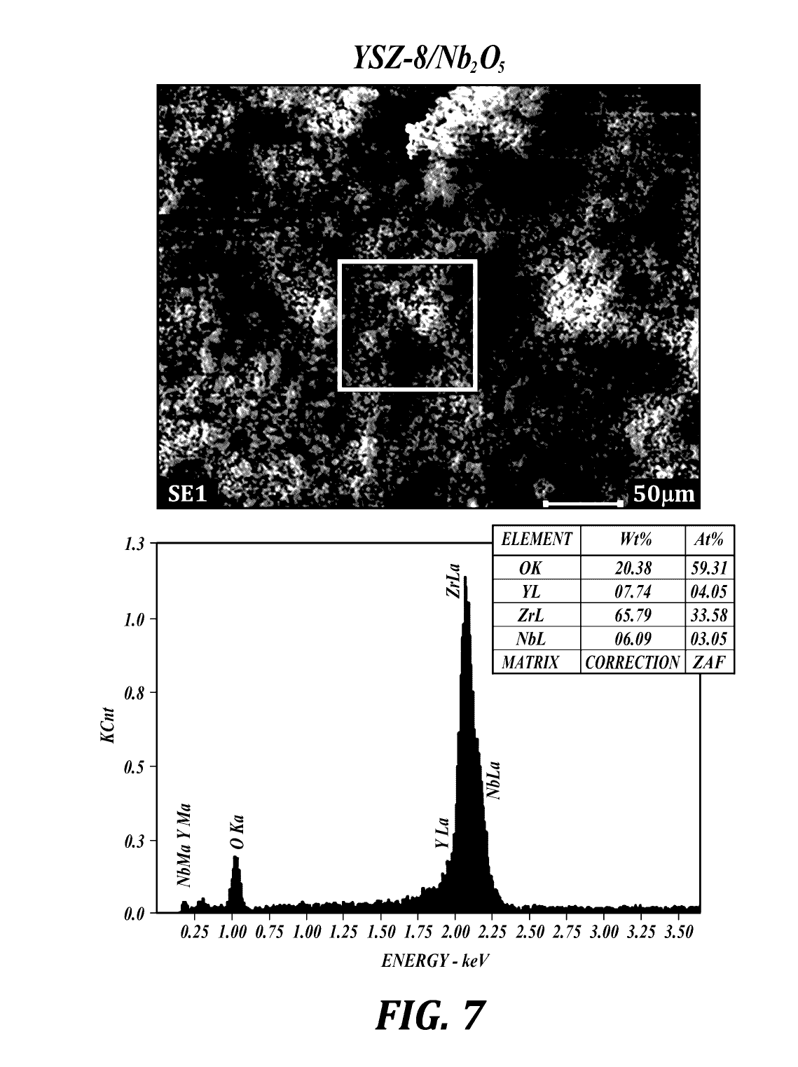

The effect of N₂O₅ surface modification on the surface area of metal oxide catalyst precursors is shown in Table 7. SEM/EDAX analysis of the surface-modified precursors is shown in FIGS. 5-7, which demonstrate the relative ease and effectiveness of surface modification of metal oxide catalysts in a systematic and controlled manner using organometallic alkoxide reagents that contain the metal species of choice.

TABLE 7
Effect of Nb₂O₅ surface modifier on BET surface area of metal oxide particles

| Property | YSC-10 | YSC-10/Nb | CeO₂—ZrO₂ | CeO₂—ZrO₂/Nb | YSZ-8 | YSZ-8/Nb |
|---|---|---|---|---|---|---|
| Nb₂O₅ | 0 | 3.4 | 0 | 5 | 0 | 7.7 |
| Loading (%) | | | | | | |
| BET Surface | 45.4736 | 358066 | 40.6634 | 36.3771 | 17.187 | 12.3182 |
| Area | | | | | | |
| (m³/g) | | | | | | |
| Decline in | n/a | 21.3 | n/a | 10.5 | n/a | 28.3 |
| Surface Area | | | | | | |
| (%) | | | | | | |

### Example 4

### Platinum-Free DOC Composition

Washcoat compositions shown in Table 8 were applied to cordierite core samples as described in Example 1, and treated with either nickel acetate in methanol, or a mixture of nickel and palladium acetates in methanol, to obtain containing 0.01 g absolute amount of Ni and ≦0.01 g absolute amount of Pd. These metal species were reduced with sodium formate, as described for the core samples prepared in Example 2. These core samples are examples of Pt-free DOC catalyst compositions according to this invention.

TABLE 8
Ni—Pd DOC Compositions

| | | | | Preferred Reagents | |
|---|---|---|---|---|---|
| | | | | in Sequence | |
| | | Cation | | Ni-Acetate | Pd-Acetate |
| Item # | Starting Catalyst | Species | | in MeOH | in Acetone |
| 1 | YSZ-8/YSC-10 (1:1) | Ni²⁺ | Pd²⁺ | Y | Y |
| 2 | YSZ-8/YSC-10 (1:1) | | Pd²⁺ | n/a | Y |
| 3 | CeO₂—ZrO₂ | Ni²⁺ | Pd²⁺ | Y | Y |
| 4 | CeO₂—ZrO₂ | | Pd²⁺ | n/a | Y |
| 5 | NiO-YSZ (66:34)/ | Ni²⁺ | Pd²⁺ | Y | Y |
| | YSZ-10 (1:1) | | | | |
| 6 | Lanthanum Strontium | Ni²⁺ | Pd²⁺ | Y | Y |
| | Cobaltite, | | | | |
| | LSC-82 | | | | |
| | [La₀.₈Sr₀.₂CoO₃] | | | | |

While illustrative embodiments have been illustrated and described, it will be appreciated that various changes can be made therein without departing from the spirit and scope of the invention.

1. A diesel oxidation catalyst, comprising:
a metal oxide comprising a metal element on a metal oxide surface, and less than 10 g/ft³ by weight of Pt or Pd, wherein the diesel oxidation catalyst oxidizes carbon monoxide and hydrocarbons of a diesel exhaust to carbon dioxide and water.

2. The diesel oxidation catalyst of claim 1, wherein the metal element is selected from Nb, Ca, Sc, Ta, Ti, V, Cr, Mn, Mo, Al, Si, Ge, Ir, Os, Fe, Co, Ni, Cu, Y, Zr, Ru, Rh, Pd, Pt, Ag, Ba, W, La, Ce, Sr, and Re.

3. The diesel oxidation catalyst of claim 1, wherein the metal element is present in the diesel oxidation catalyst in an amount of from 0.001 to 40% by weight.

4. The diesel oxidation catalyst of claim 1, wherein the metal oxide comprises less than 5 g/ft³ by weight of Pt or Pd.

5. The diesel oxidation catalyst of claim 1, wherein the metal oxide comprises less than 0.001 g/ft³ by weight of Pt or Pd.

6. The diesel oxidation catalyst of claim 1, wherein the metal oxide is selected from cerium oxide, titanium oxide, zirconium oxide, aluminum oxide, silicon oxide, hafnium oxide, vanadium oxide, niobium oxide, tantalum oxide, chromium oxide, molybdenum oxide, tungsten oxide, ruthenium oxide, rhodium oxide, iridium oxide, nickel oxide, lanthanum oxide, strontium oxide, cobalt oxide, and any combination thereof.

7. The diesel oxidation catalyst of claim 6, wherein the metal oxide further comprises a cationic dopant selected from Sr²⁺, Ru⁴⁺, Rh³⁺, Mg²⁺, Cu²⁺, Cu³⁺, Ni²⁺, Ti⁴⁺, V⁴⁺, Nb⁴⁺, Ta⁵⁺, Cr³⁺, Mo³⁺, W⁶⁺, W³⁺, Mn²⁺, Fe³⁺, Zn²⁺, Ga³⁺, Al³⁺, In³⁺, Ge⁴⁺, Si⁴⁺, Co²⁺, Ni²⁺, Ba²⁺, La³⁺, Ce⁴⁺, and Nb⁵⁺.

8. The diesel oxidation catalyst of claim 1, wherein the metal oxide is selected from titanium oxide, zirconium oxide, cerium oxide, and any combination thereof.

9. The diesel oxidation catalyst of claim 8, wherein the metal oxide further comprises a cationic dopant selected from Y³⁺, Sc³⁺, and Ca²⁺.

10. The diesel oxidation catalyst of claim 9, wherein the metal oxide is selected from yttria-stabilized zirconia, yttria-stabilized ceria, and a combination thereof.

11. The diesel oxidation catalyst of claim 1, wherein the diesel oxidation catalyst is hydrothermally stable when heated for 40 hours at 650° C.

12. The diesel oxidation catalyst of claim 1, having a 50% hydrocarbon to CO₂ and H₂O conversion temperature of about 300° C. or less.

13. The diesel oxidation catalyst of claim 1, having a 50% NO to NO₂ and H₂O conversion temperature of about 300° C. or less.

14. The diesel oxidation catalyst of claim 1, comprising a layer of amalgamation between the metal oxide surface and the metal element, wherein the metal oxide and the metal element are intimately mixed.

15. A substrate comprising a coating of a diesel oxidation catalyst of claim 1 wherein the substrate is a catalytic converter support, a diesel particulate filter, or a combined catalytic converter support and a diesel particulate filter.

16. The substrate of claim 15, wherein the substrate is selected from a cordierite catalytic converter support, a cordierite wall flow filter, a silicon carbide wall flow filter, a ceramic fiber filter, and a metal fiber flow-through filter.

17. The diesel oxidation catalyst of claim 1, wherein the diesel oxidation catalyst is in the form of a particle or a coating.

18. A method of oxidizing NO in diesel engine exhaust in a selective catalytic oxidation system, comprising:
exposing a NO-containing diesel engine exhaust to a diesel oxidation catalyst of claim 1, and
oxidizing the NO to NO₂,
wherein the diesel oxidation catalyst is disposed on or within a catalyst support structure.

19. The method of claim 18, wherein the diesel oxidation catalyst further oxidizes a hydrocarbon in a hydrocarbon-containing diesel engine exhaust to CO₂ and H₂O.

20. The method of claim 18, wherein the catalyst support structure is a ceramic monolith or a metallic substrate.
